(19) United States
(12) Patent Application Publication
(10) Pub. No.: US 2010/0226114 A1
(43) Pub. Date: Sep. 9, 2010

(54) ILLUMINATION AND IMAGING SYSTEM

(76) Inventor: David Fishbaine, Minnetonka, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 12/716,432

(22) Filed: Mar. 3, 2010

Related U.S. Application Data
(60) Provisional application No. 61/157,020, filed on Mar. 3, 2009.

(51) Int. Cl. G03B 15/02

(52) U.S. Cl. 362/16

(57) ABSTRACT

An illumination and imaging system and method include a light source, an image capture device, a first mirror situated at a predetermined position relative to the light source, and a second mirror situated at a predetermined position relative to the image capture device.

### CROSS-REFERENCE TO RELATED APPLICATIONS

This Utility Patent Application is a non-provisional application of U.S. Provisional Application Ser. No. 61/157,020, filed Mar. 3, 2009, which is incorporated herein by reference.

### BACKGROUND

Imaging devices that incorporate structured or directional light sources often project light onto a target surface from a source angle different from a viewing angle. This can, depending on the target surface topology, create a shadow condition, herein called Source Shadowing, where the viewing device, herein called a Viewer, can see a point on the target surface but the source light is prevented from reaching that point.

Any viewing device, while looking at a three dimensional target surface from a fixed vantage point, may be unable to see all portions of that target surface, depending on the target surface topology. This viewer obscuration condition is herein called Viewer Shadowing.

Attempts to mitigate these shadow conditions include the following.

There are ‘Multi-Eye’ sensors which mitigate the Viewer Shadowing case by observing the target surface from more than one viewing angle. They achieve this by having two or more camera systems, comprised of separate optics, photo-detecting systems and associated electronics, disposed at angles to one another and observing a focal point plane where structured or directional light from the source will strike the target. These systems are bulky and costly due to their replication of hardware.

A phase profilometry system 3D inspection system, able to mitigate Source Shadowing using multiple source angles, achieved by using macroscopically moving parts, has been disclosed. The macroscopically moving part in this system is a mirror. The mirror moves, either by sliding or rotating, and so directs the source light to one of a plurality of optical channels. Each optical channel is disposed to deliver the light to a target surface from a source angle different from any of the other optical channels. This system is slow, costly and is unreliable due to its moving parts.

A single system able to overcome both shadowing conditions without resorting to macroscopically moving parts or multiple projectors and/or multiple cameras is desirable. For these and other reasons, there is a need for the present invention.

### SUMMARY

In accordance with aspects of the present invention, an illumination and imaging system, comprising a single light projector and a single camera, is able to project light onto a plurality of focal planes from multiple incident directions and is further able to view a plurality of focal planes from multiple observation directions without macroscopically moving parts.

### BRIEF DESCRIPTION OF THE DRAWINGS

FIG. 1A illustrates portions of an SMT assembly process.

FIG. 1B is a simplified illustration of surface illuminated by a directional light source where the surface is such that a Source Shadowing condition occurs.

FIG. 2 is an illustration of surface viewed from only one viewing angle where the surface is such that a Viewer Shadowing condition occurs.

FIGS. 3-5 illustrate a system able to illuminate a target surface from multiple projection angles using one light projector and no macroscopically moving parts.

FIGS. 6-8 illustrate a system able to view a target surface from multiple viewing angles using one camera and no moving parts.

FIGS. 9-11 illustrate a system able to view a target surface from multiple viewing angles using one camera and no moving parts and also able to illuminate a target surface from multiple projection angles using one light projector and without macroscopically moving parts.

FIGS. 12 and 13 illustrate a system able to synthetically extend the viewer's depth of focus.

FIGS. 14-16 illustrate a system able to illuminate a target surface from multiple projection angles using one light projector and no macroscopically moving parts.

FIGS. 17-19 illustrate a system able to view a target surface from multiple viewing angles using one camera and no moving parts.

FIGS. 20-22 illustrate a system able to view a target surface from multiple viewing angles using one camera no moving parts and also able to illuminate a target surface from multiple projection angles using one light projector and without macroscopically moving parts.

### DETAILED DESCRIPTION

In the following Detailed Description, reference is made to the accompanying drawings, which form a part hereof, and in which is shown by way of illustrating specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

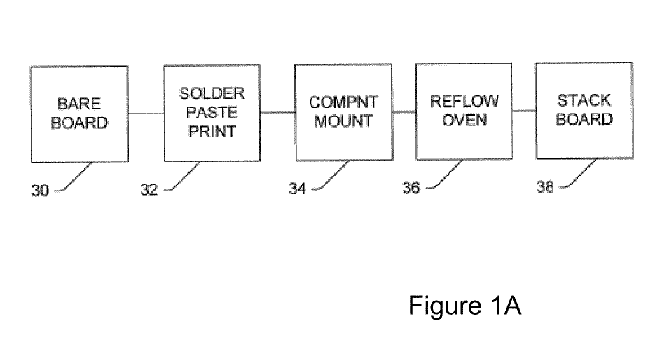

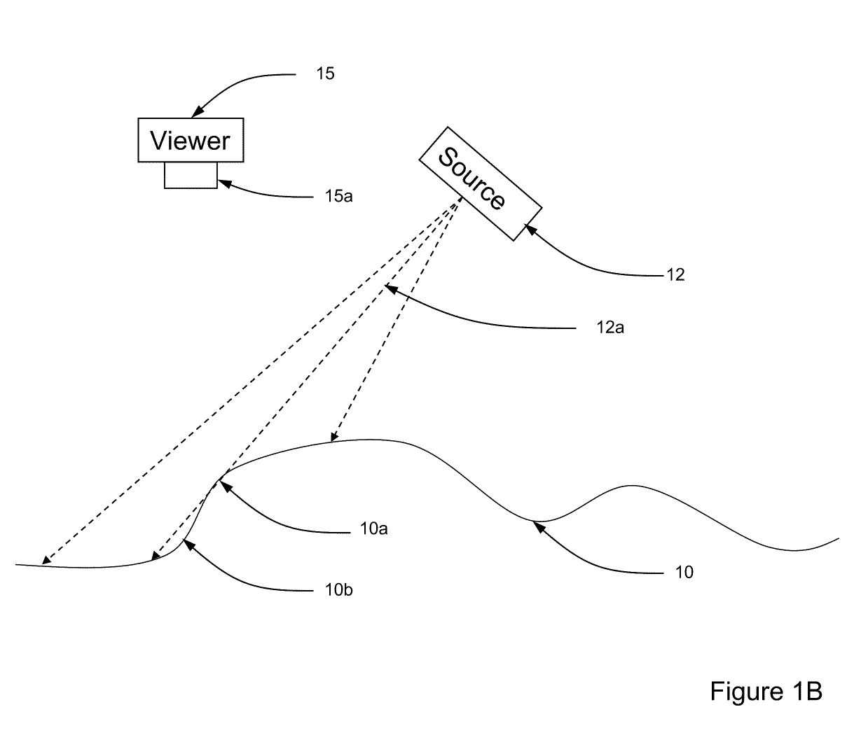

Many manufacturing processes, such as those for electronic components and assemblies include inspection and test procedures, which can be either manual or automated. Electronic components, for example, are often mounted on a circuit board, and the components are tested before and/or after final assembly. For example, the surface mount assembly process (SMT) consists fundamentally of three value added process steps: Solder paste printing, component mounting and reflow. These are schematically illustrated in FIG. 1A. Un-stack bare board 30 removes a single bare circuit board from a stack of them and inserts it into the assembly line. Solder paste print 32 prints solder paste onto the bare circuit board. Component mount 34 moves components from a component bulk feed apparatus (not shown) and places them onto the circuit board. Reflow oven 36 melts the solder paste and then allows it to cool and re-solidify. Stack populated board 38 takes at least partially assembled circuit boards and stacks them into an easily portable batch.

Several types of errors can occur during these manufacturing processes. Electrical test alone is generally understood to be an incomplete quality control approach. To supplement electrical test, SMT operators nearly always implement some sort of visual inspection approach at the end of the assembly line (after reflow). One type of inspection is by human visual. Another, often more suitable approach, is in-line AOI (Automatic Optical Inspection) and sometimes X-Ray (automatic or manual) inspection. Among other things, such AOI process includes illuminating the component under test.

Referring to FIG. 1B, a surface 10 (such as the surface of a component under test) is illuminated only with light from light source 12. Ray 12a from source 12 is tangent to a point 10a of surface 10 and therefore no light, emitted from source 12, can reach the shadow region 10b of surface 10. Although shadow region 10b is entirely viewable by Viewer 15 through optics 15a, shadow region 10a will appear to be dark. Therefore, the illustrated combination of surface shape, illumination angle and viewing angle has created a Source Shadowing condition.

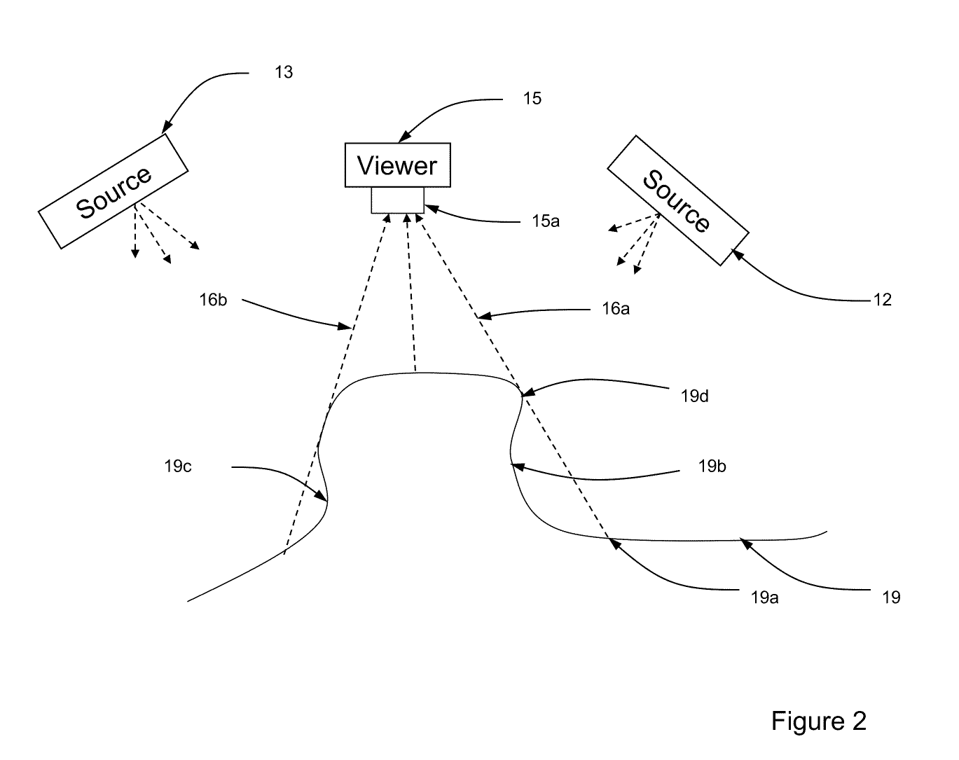

Referring to FIG. 2, surface 19 is illuminated with light from light sources 12 and 13. Incident light is scattered at surface point 19a and some of it is scattered towards the viewer as is illustrated by ray 16a. Ray 16a is tangent to point 19d of surface 19 and therefore surface region 19b is hidden from Viewer 15. A similar situation is illustrated by ray 16b and hidden region 19c. Therefore, the illustrated combination of surface shape and viewing angles has created a Viewer Shadowing condition.

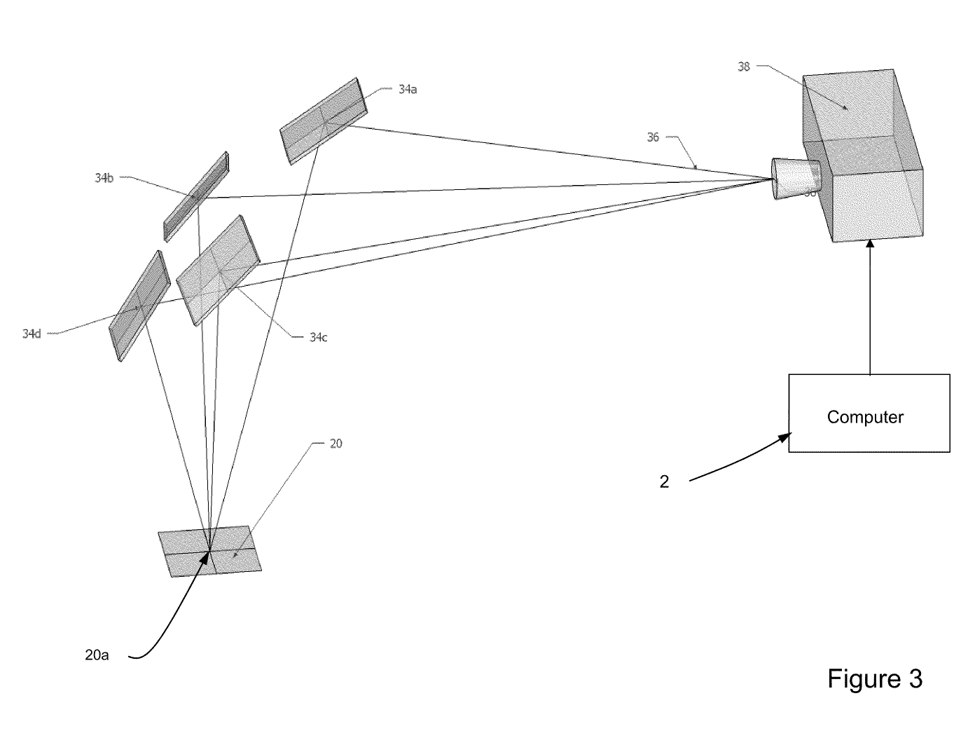

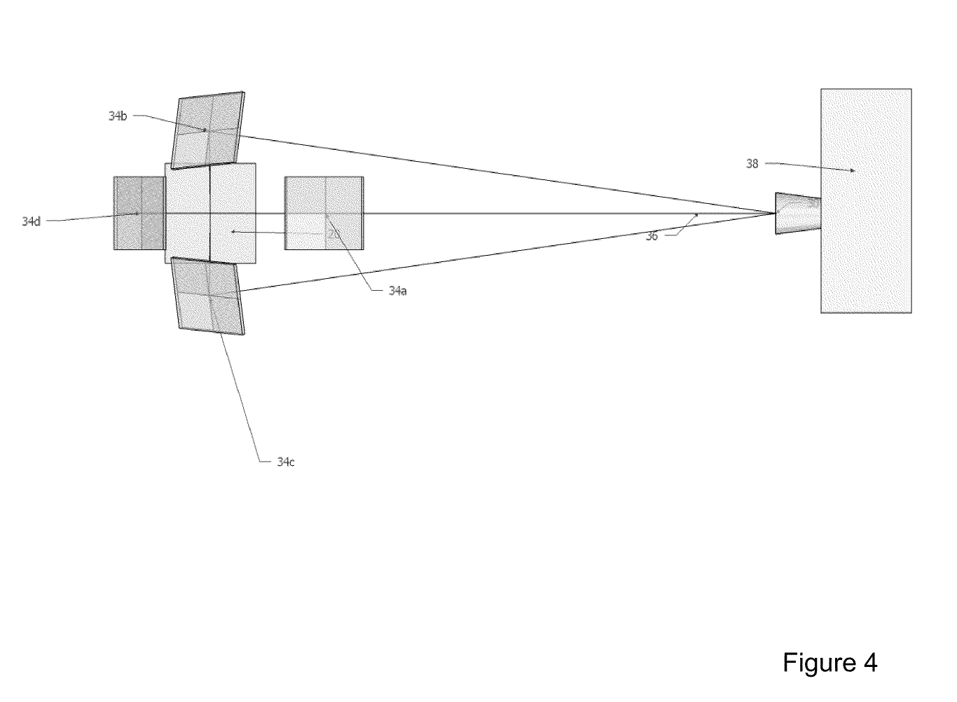

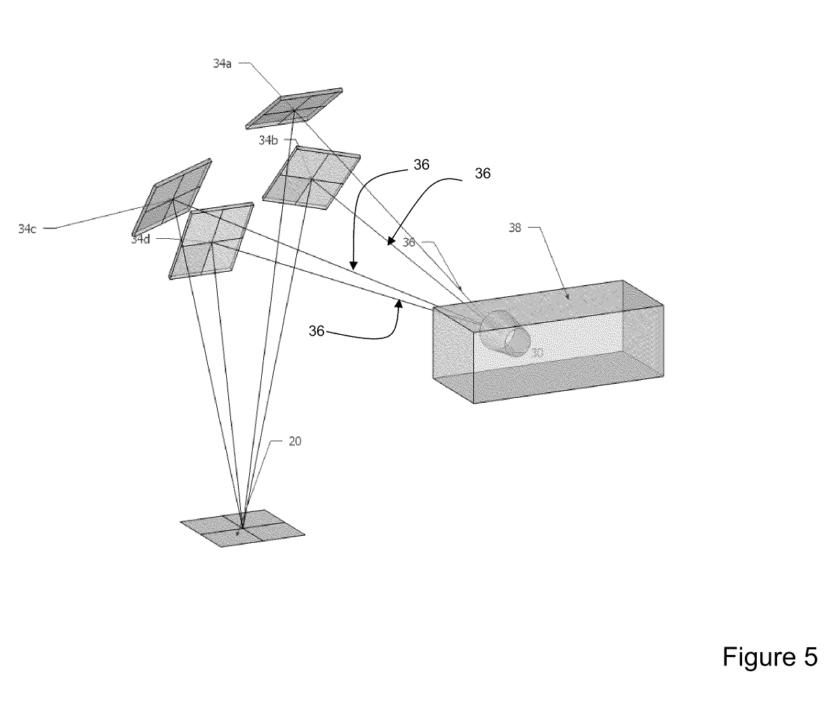

Referring now to FIGS. 3-5, light projector 38 includes a spatial light modulator (SLM). An SLM is an object that imposes some form of spatially-varying modulation on a beam of light, typically controlled by a computer. Home theater or business projectors include an SLM, such as a liquid crystal display (LCD), liquid crystal on silicon LCoS or a digital light processor (DLP). Projector 38 acts under control of computer 2 so as to project light onto, and thereby select, a subset of four illumination mirrors 34a-34d. Note that computer 2 is omitted from FIGS. 4 and 5 for clarity. For simplicity, the various disclosed embodiments employ mirrors such as the illumination mirrors 34a-34d. However, it would be clear to one of ordinary skill in the art having the benefit of this disclosure that the function of mirrors, using reflection, can be duplicated by lenses or prisms that use refraction, or by gratings that use diffraction, to achieve the same thing.

The remaining mirrors are deselected in the sense that no light is intentionally projected in their directions. One or more patterns can then be directed toward the selected mirrors so as to deliver, to surface 20, structured light as is required by the inspection technique, for example triangulation range finding. Light, structured or not, so delivered has a source incident angle determined by the physical arrangement of projector 38 and illumination mirrors 34a-34d. Thus, in the illustrated embodiment, the source incident angles can be selected from one of four angles, under computer control and without macroscopically moving parts.

International Patent Application Publication No. WO2008/124397, which is incorporated by reference, discloses a system wherein an LCD projector's entire field of projection (FOP) is divided into more than one portion by mirrors where each section is then further directed by those mirrors or additional mirrors to deliver light to a target surface from more than one source angle. The undesired angles are disabled when the portions of the projector's FOP corresponding to those angles are substantially dark. Conversely, desired angles are enabled when the portions corresponding to those angles are at least partially lit. Structured illumination is achieved by projecting a pattern into the enabled optical channel. Thus the Source Shadowing problem is mitigated without macroscopically moving parts.

In another disclosed system, a plurality of light generating subsystems, comprised of a light source and optics, is deployed at varying angles relative to a micro-mirror array such as a DLP. Additionally, a plurality of optical channels is deployed relative to the micro-mirror array such that there is a one-to-one correspondence between a light energy subsystem and an optical channel. Thus, when any one light source is energized, one and only one optical channel is illuminated. Each optical channel is disposed to deliver the light to a target surface from a source angle different from the others. As is standard for these devices, structure or intensity modulation can be imparted to the light by controlling the duty-cycle of the micro-mirror array over an exposure time that substantially exceeds the switching time of the micro-mirrors. Thus the Source Shadowing problem is mitigated without macroscopically moving parts.

Illumination mirrors 34a-34d are arranged on the surface of an oblate spheroid so that the convergence point 30 of chief rays 36 within projector 38 and the convergence point 20a of those rays on surface 20 are coincident with said oblate spheroid's foci. Thus, the optical path length between the two convergence points 30 and 20a is constant, regardless of which mirror is selected. Although the focal plane corresponding to each illumination mirror intersects convergence point 20a, no two such focal planes are parallel. In many inspection applications this lack of parallelism over the field of view will be inconsequential. This arrangement of mirrors 34 is optimal when the surface to be illuminated is substantially flat. For other illumination applications, where the surface topology is not nominally flat, mirrors 34 would be arranged differently as is optimal for that topology.

The arrangement depicted in FIGS. 3-5 does not make efficient use of light or of the projector's inherent resolution. For example, if only one illumination mirror is selected at a time, most of the light available from the lamp within the projector is unused. Similarly, since the FOP must span all illumination mirrors, only a small portion of the projector's inherent resolution, that which falls on the selected mirror(s), can be used at a time. Additionally, there is a waste of resolution that occurs in the dead space, or gaps, between mirrors. These inefficiencies are a byproduct of using an off-the-shelf projector 38. However, modern off-the-shelf projectors have light sources and resolutions that exceed the needs of many inspection and measurement tasks and in those cases the loss of light or resolution is inconsequential. International Patent Application Publication No. WO2008/124397 discloses projectors that make efficient use of light and resolution while permitting that light to be directed to distinct optical channels.

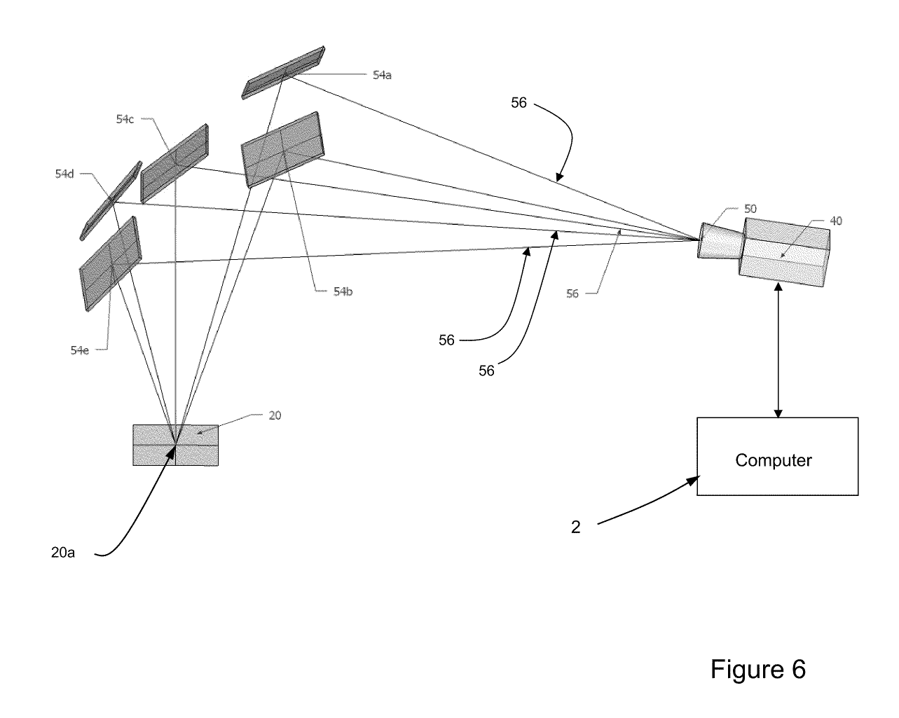

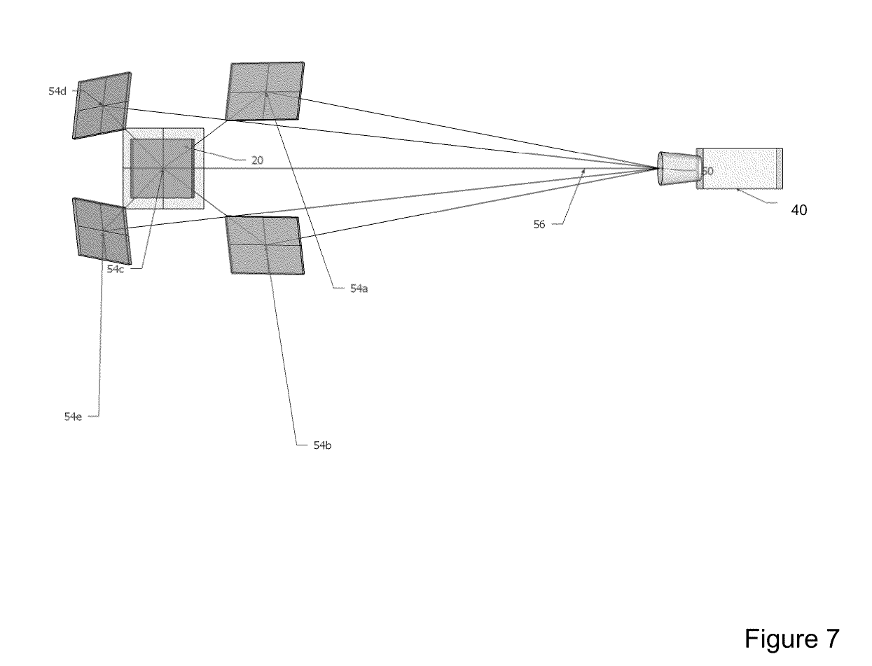

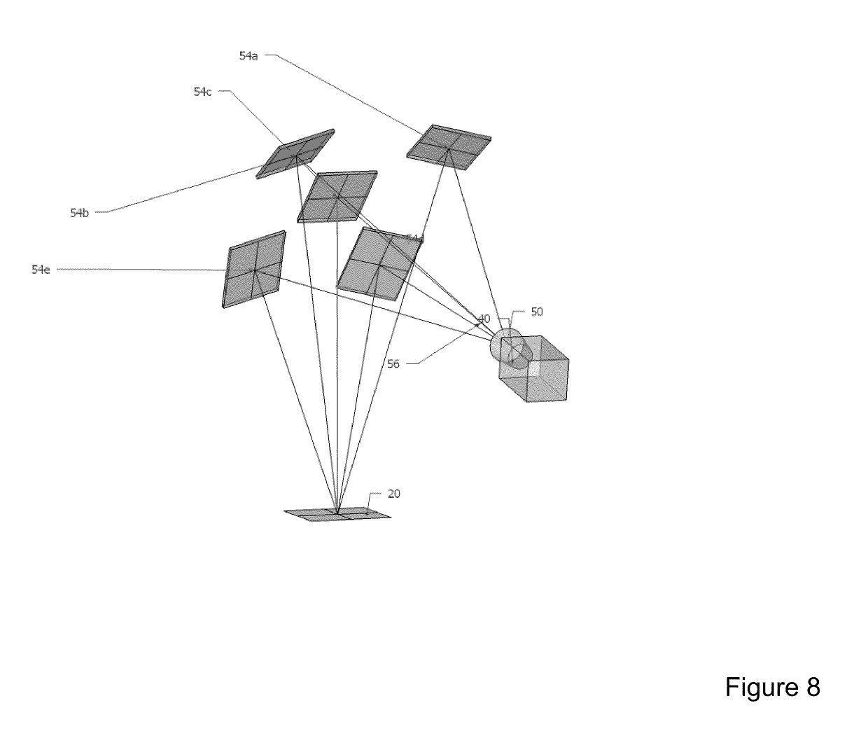

Refer now to FIGS. 6-8. Light scattered or emitted by a surface at or near plane 20 will reach all five viewing mirrors 54a-54e. Said viewing mirrors are all encompassed within the field of view (FOV) of an image capture device such as camera 40. Said camera is controlled by, and image data from said camera are delivered to, a computer 2. Note that computer 2 is omitted from FIGS. 7 and 8 for clarity.

The viewing mirrors 54a-54e are arranged on the surface of an oblate spheroid so that the convergence point 50 of chief rays 56 within camera assembly 40 and the convergence point 20a of those rays on plane 20 are coincident with said oblate spheroid's foci. Thus, the optical path length between the two convergence points 50 and 20a is constant, regardless of which mirror is selected for viewing.

Although the focal plane corresponding to each viewing mirror intersects convergence point 20a, no two such focal planes are parallel. In many inspection applications this lack of parallelism over the field of view will be inconsequential. This arrangement of mirrors 54 is optimal when the surface to be viewed is substantially flat. For other viewing applications, where the surface topology is not nominally flat, mirrors 54 would be arranged differently as is optimal for that topology. Thus, all views are obtained simultaneously from five viewing angles without any moving parts.

This simultaneous ability to look from multiple viewing angles is achieved by sacrificing resolution; since the camera's field of view (FOV) must span all five mirrors, each viewing angle uses only a small portion camera's inherent resolution. Furthermore, the mirrors as illustrated are not adjacent to one another so additional resolution of the camera is wasted in the dead space where there are gaps. However, modern cameras have resolutions that exceed the needs of many inspection or measurement tasks and in those cases the loss of resolution is inconsequential.

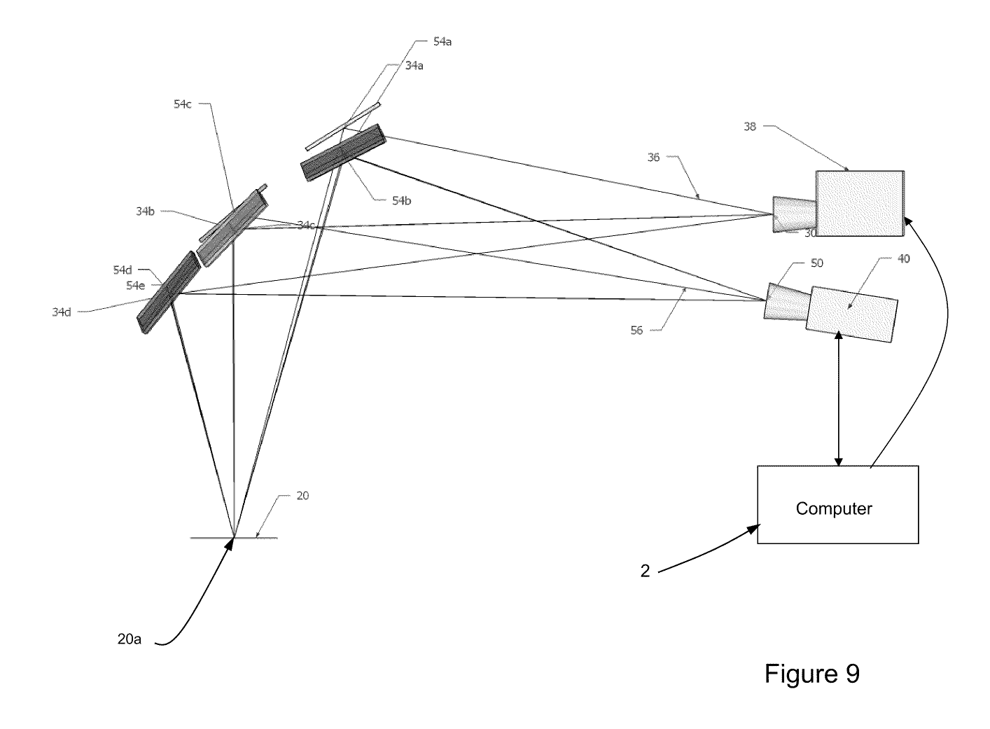

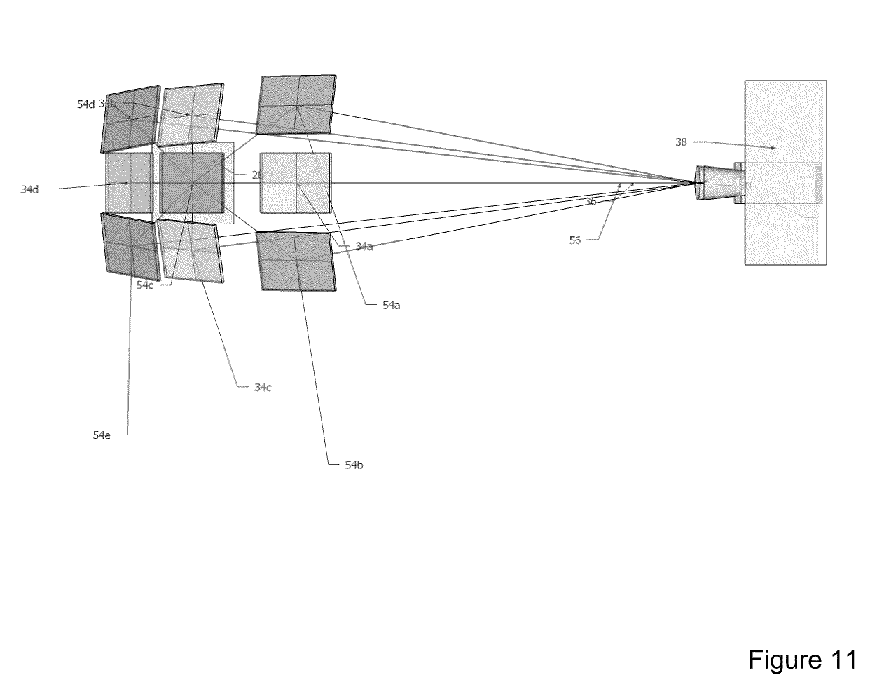

Refer now to FIGS. 9-11 where the illumination system of FIGS. 3-5 and the viewing system of FIG. 6-8 are combined. The aforementioned gaps in the viewing system are now filled with the mirrors from the illumination system. The two oblate spheroids, one for the illumination system and one for the viewing system, each have a focus at first convergence point 20a. In this fashion, the light projected through the illumination mirrors 34 and the target surface viewed through the viewing mirrors 54 have focal planes which, although they are not parallel, all intersect convergence point 20a.

Although FIGS. 9-11 have the illumination mirrors 34a-34d located between viewing mirrors so that said illumination mirrors will fall within the FOV of the camera, it should be clear that some useful mirror configurations would place the illumination mirrors outboard of the viewing mirrors. This configuration is of increased utility if the previously disclosed projection techniques that preserve projected light and resolution are employed.

The illumination and viewing systems have so far been treated as though they are independent, yet in the embodiment of FIGS. 9-11, all nine mirrors (34 and 54) are within the FOV of the camera 40. Thus, camera 40 is able to view target surface 20 not only through the viewing mirrors 54, but also through the illumination mirrors 34. Because the camera pupil 50 is not located at a focus of the illumination oblate spheroid (that focus is at the projector pupil 30), the views of the target surface through illumination mirrors 34 will be laterally offset, tilted and out-of-plane. These displacements may be small compared to the application's requirements. Furthermore, these views are potentially beneficial because they:

Provide additional viewing angles

Allow for synthetic extension of the field of view

Allow for synthetic extension of the depth of field.

Also, the projector 38 is able to illuminate the target surface 20 not only through the illumination mirrors 34, but also through the viewing mirrors 54. Because the projector pupil 30 is not located at a focus of the viewing oblate spheroid (that focus is at the camera pupil 50), the light projected onto the target surface through viewing mirrors 54 will be laterally offset, tilted and out-of-plane. These displacements may be small compared to the application's requirements. Furthermore, these projections are potentially beneficial because they:

Provide additional projection angles

Allow for synthetic extension of the FOP

Allow for synthetic extension of the projector's depth of field.

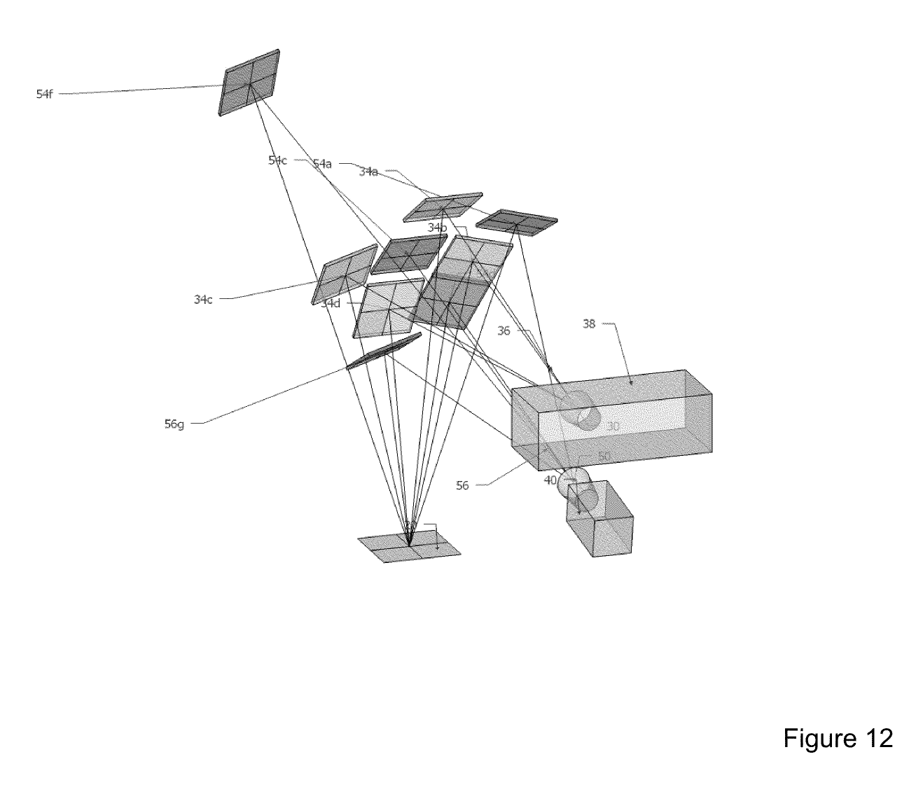

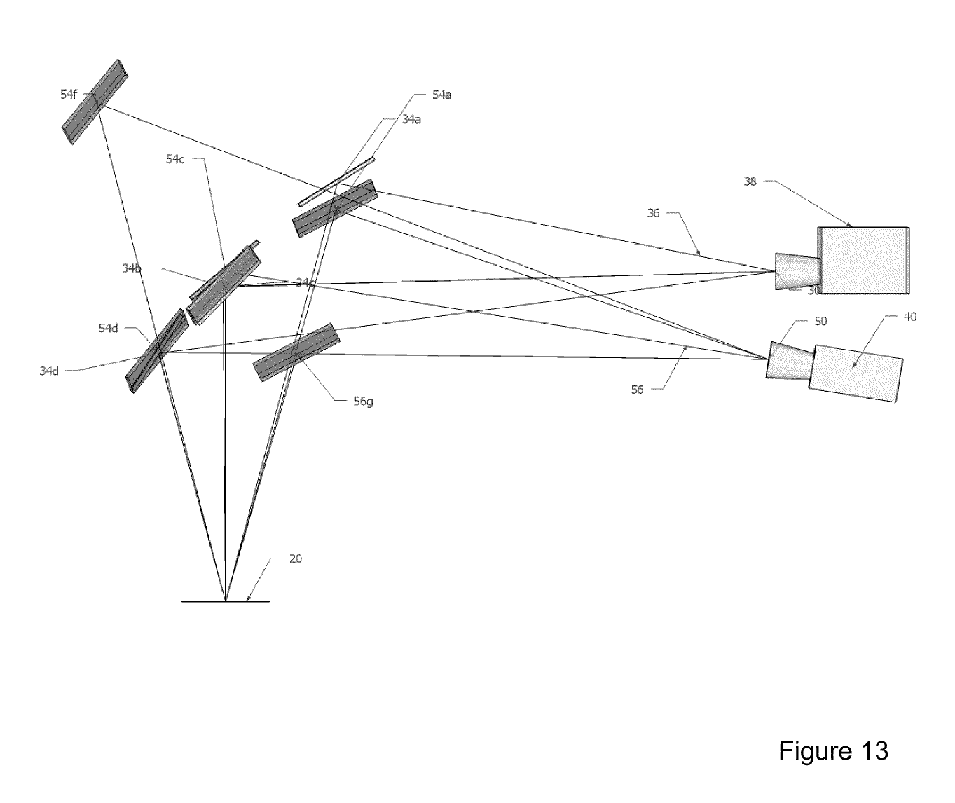

Referring now to FIGS. 12 and 13, mirrors 54f and 56g are offset in space to illustrate a configuration where it is desired to synthetically extend the viewer depth of field. As in FIG. 8, mirrors 54a, 54d, 54c are arranged so that the path lengths from pupil 50 in camera 40 to plane 20 through those mirrors are substantially equal. Thus, as in FIG. 8, camera 40's views through those mirrors are focused near plane 20.

However, mirror 54f is displaced so that the path length from pupil 50 to plane 20 is increased. Thus, camera 40's view through mirror 54f is focused above plane 20. Mirror 56g is displaced towards camera 40 and thus camera 40's view through mirror 56g is focused below plane 20. Camera 40's composite view of a surface near to plane 20 can be extended beyond what would be achievable without the displacements of mirrors 54f and 56g by selecting the data source, e.g. which mirror's images, should be emphasized depending on the target surface elevation.

Similarly, the illumination mirrors can be displaced to achieve the same effect for the projector.

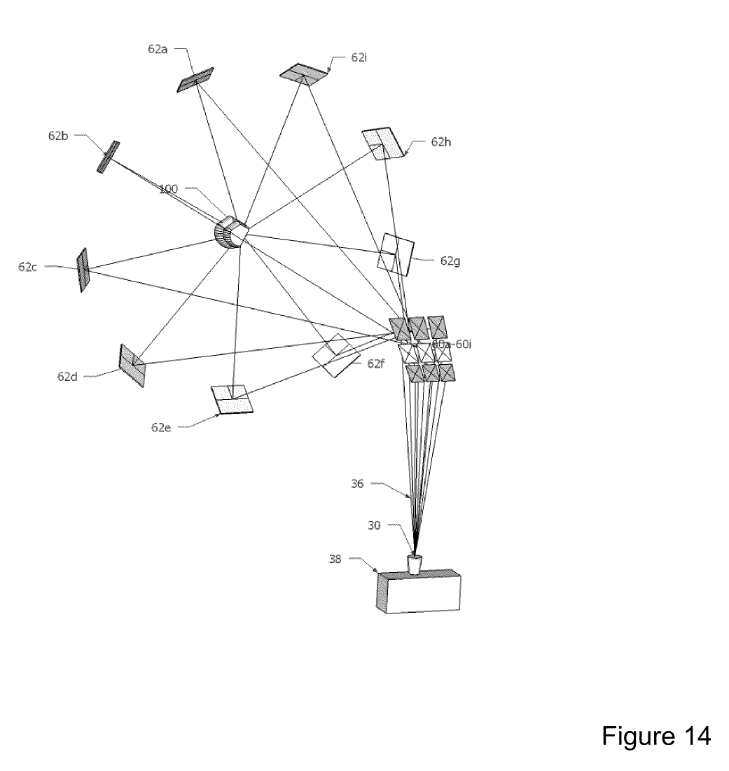

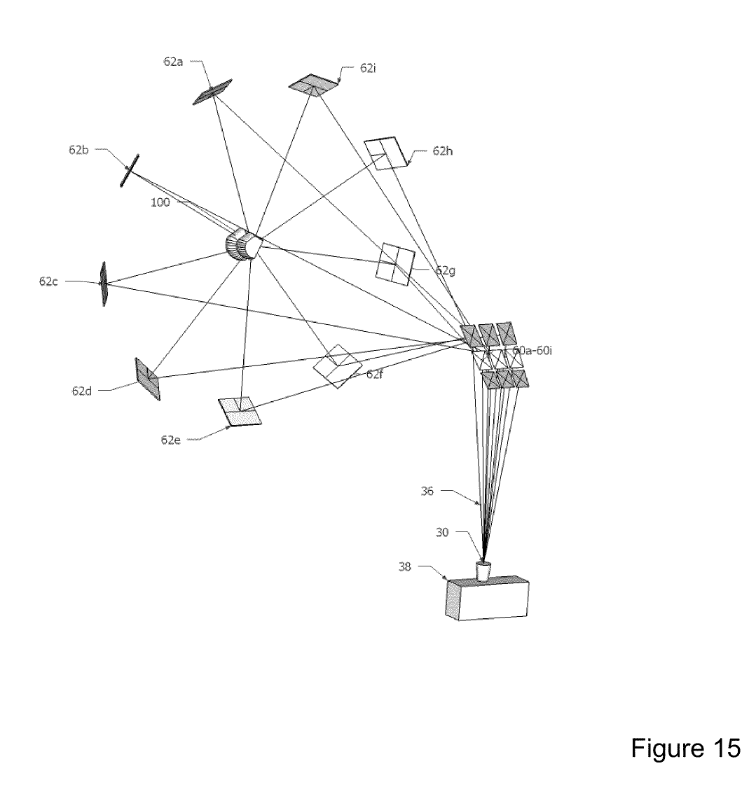

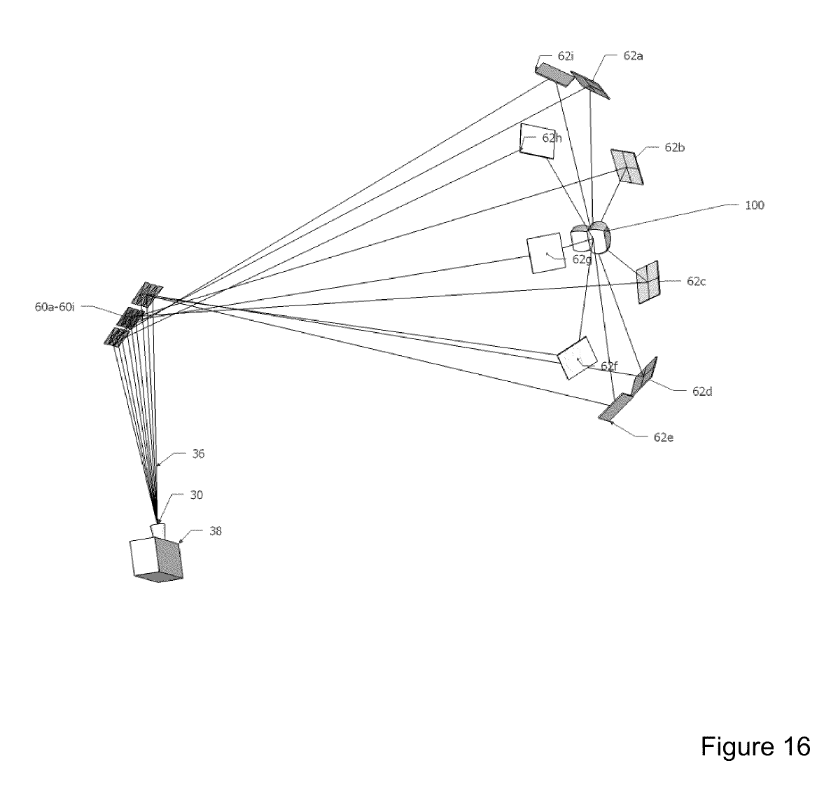

Another embodiment of the illumination system is illustrated in FIGS. 14-16. Projector 38 projects light onto target 100 through one or more of a plurality of optical paths, where each path comprises two mirrors. To follow one of the nine illustrated paths, light from projector 38 passes through pupil 30 and reaches mirror 60a. Mirror 60a is disposed to reflect said light towards mirror 62a which is, in turn, disposed to reflect said light towards target 100 from a unique direction.

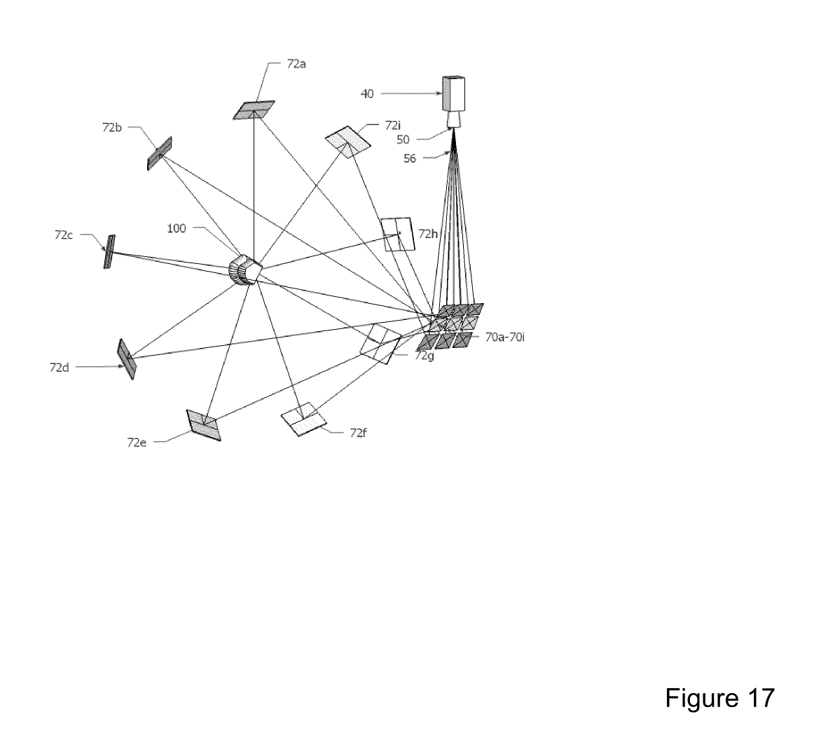

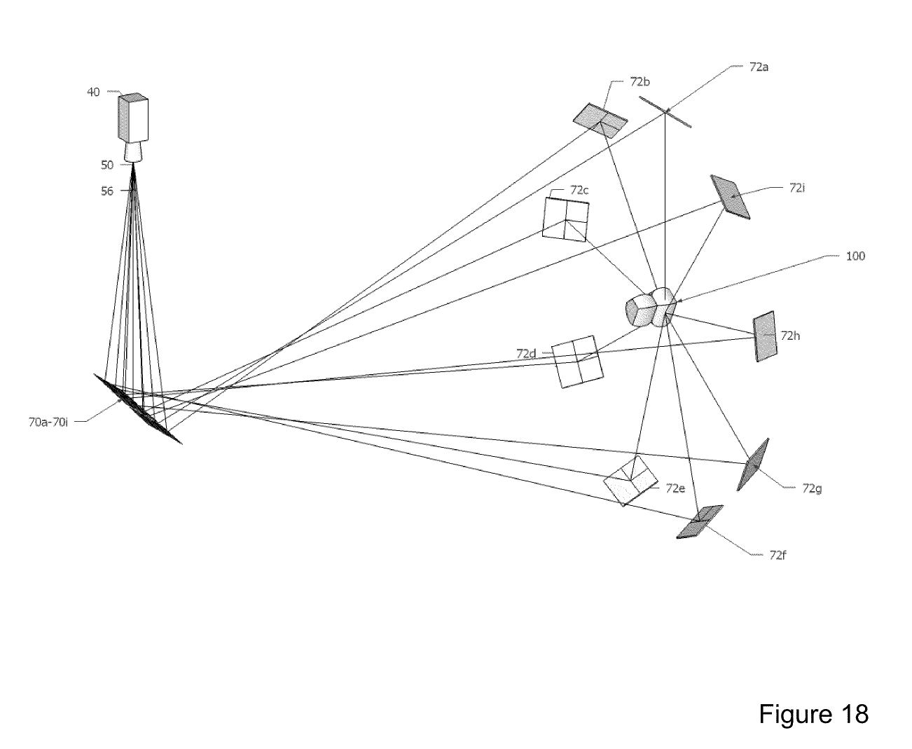

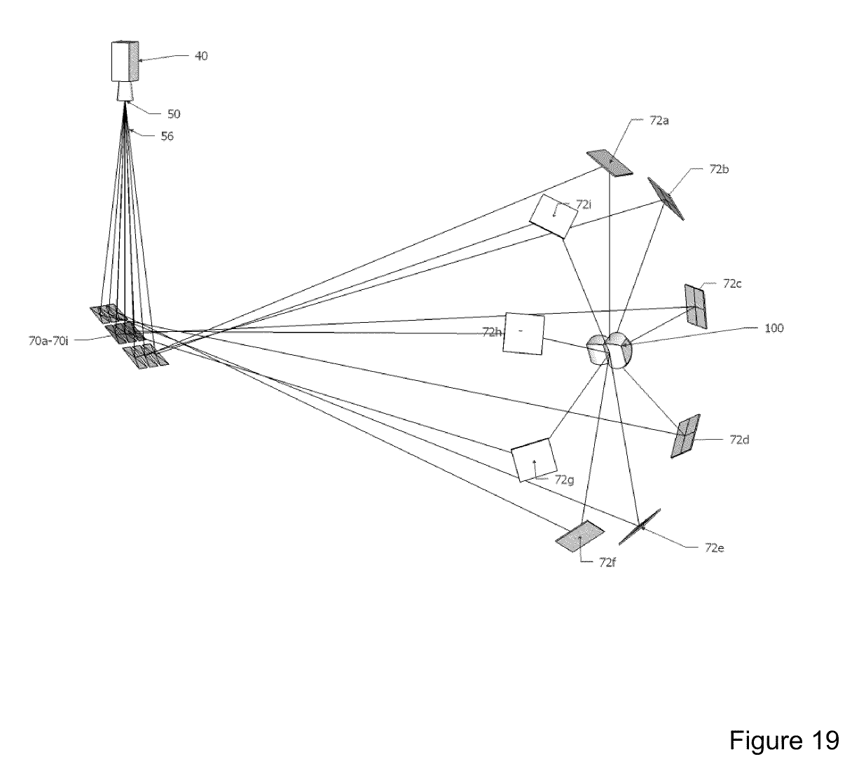

A corresponding embodiment of the viewing system is illustrated in FIGS. 17-19. Camera 40 views target 100 through a plurality of optical paths, where each path comprises two mirrors. Following one the nine illustrated paths, some of the light scattered or emitted from target 100 will reach mirror 72c which is disposed to reflect said light toward mirror 70c which is, in turn, disposed to reflect said light towards camera 40.

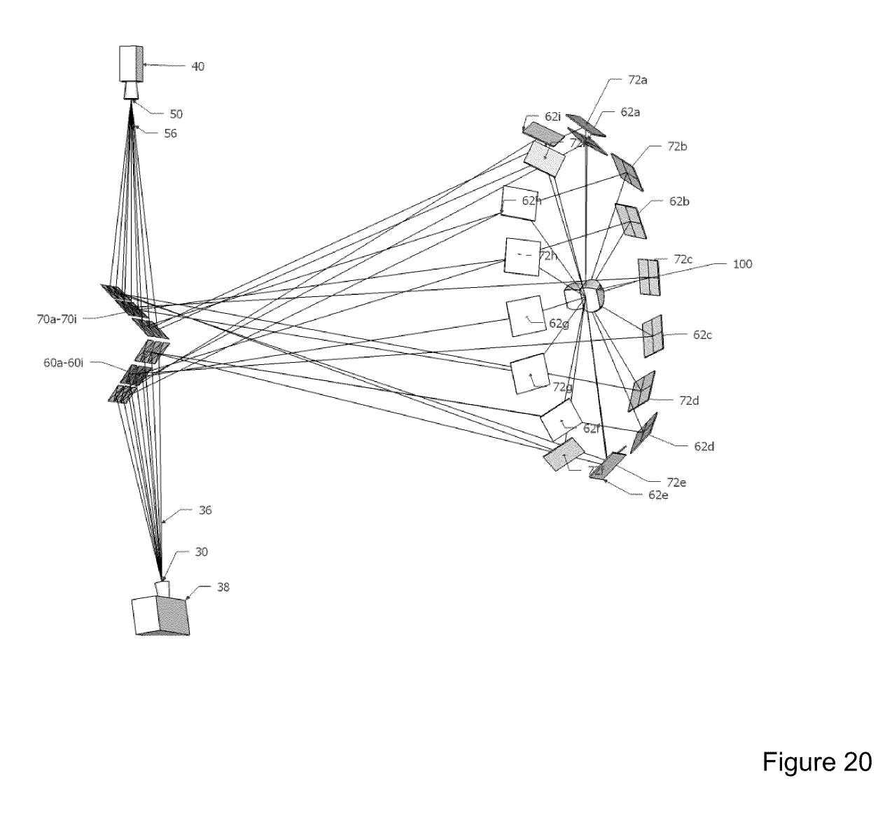

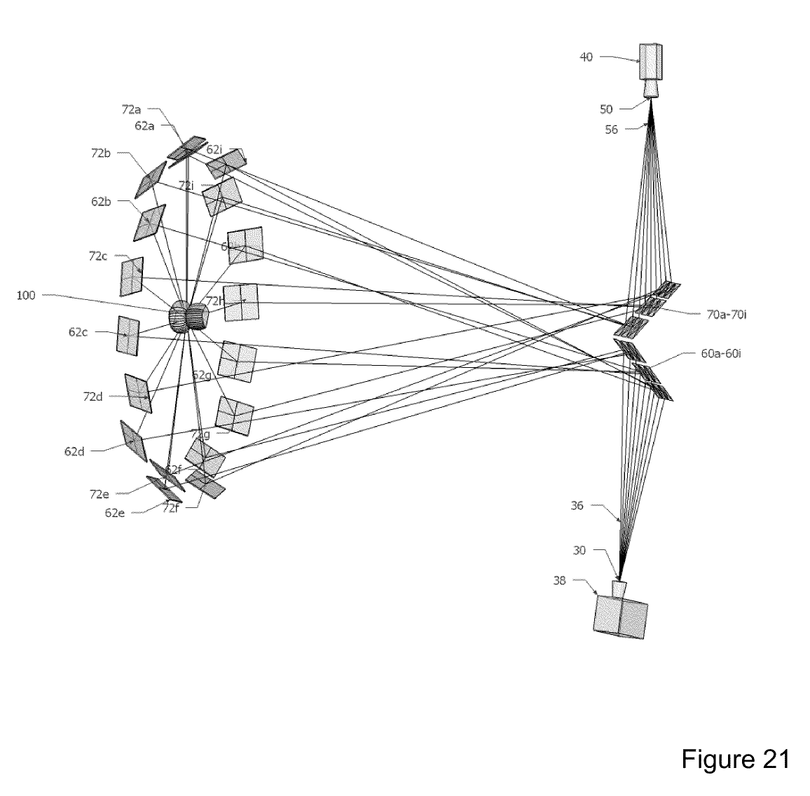

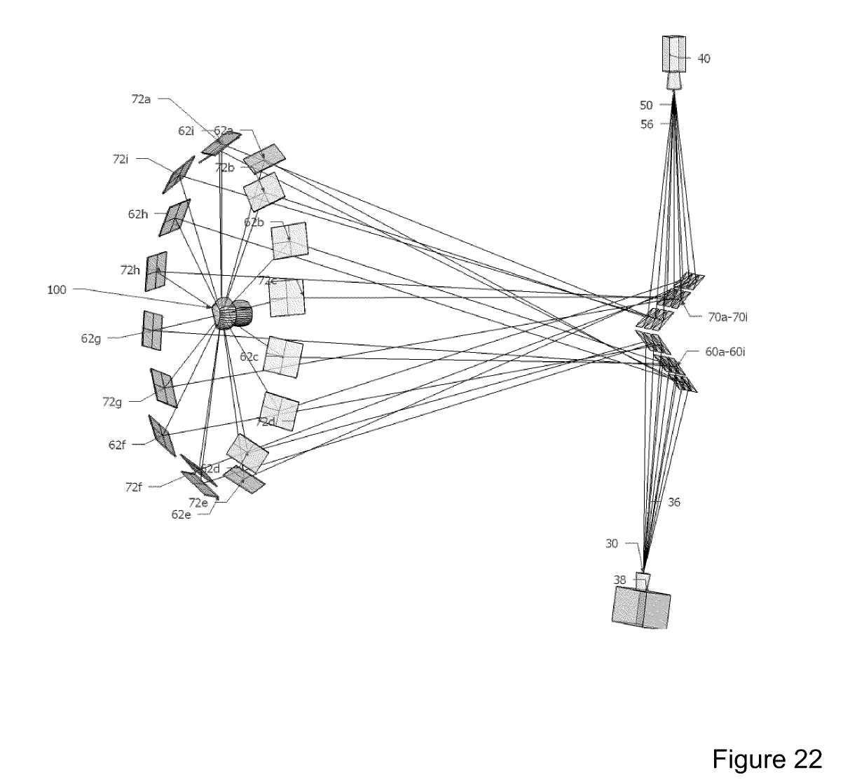

The illumination system of FIGS. 14-16 and the viewing system of FIGS. 17-19 can be combined as illustrated in FIGS. 20-22 which operates similarly to the system of FIGS. 9-11, but is optimized to illuminate and observe target 100 (which is substantially cylindrical) rather than target 20 (which is flat).

The two mirror optical path has more degrees of freedom that the single mirror optical path illustrated in FIGS. 3-13. This increased flexibility is employed in the system of FIGS. 20-22 to make maximum use of the projector and camera resolutions by minimizing dead space.

In one embodiment the system of FIGS. 9-11 (FIGS. 20-22 in parenthesis) operates as follows:

The computer 2 causes projector 38 to select one of a plurality of possible source incident angles by illuminating one of the illumination mirrors 34 (60) as described above.

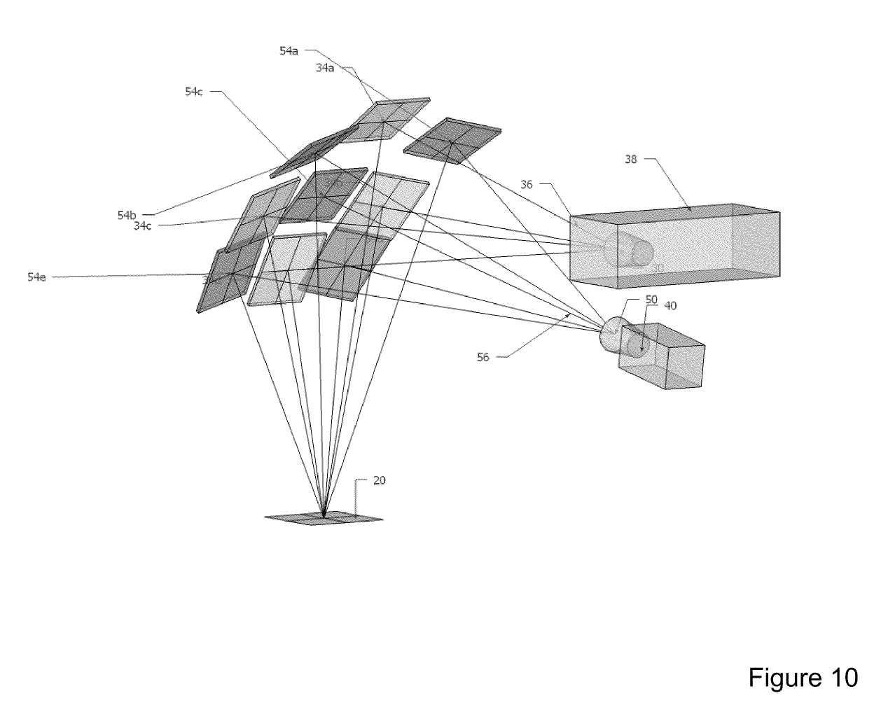

The computer 2 causes camera 40 to acquire a single image that encompasses all of a plurality of viewing mirrors 54 (70) as described above. The camera's view of the target surface 20 (100) through each of the viewing mirrors is from a distinct viewing angle. The resulting data are transferred from the camera to the computer. Note that computer 2 is omitted from FIG. 10 and onwards for clarity.

The processes described above are optionally repeated while varying the nature of the projected light. For example, in the case of phase profilometry, the light is structured and the phase of the structured light would be shifted between image acquisitions.

These processes are optionally further repeated for other source incident angles.

The data received by the computer from the camera are analyzed to produce inspection results. This analysis step need not be deferred entirely until all data are acquired. For example, in phase profilometry the images resulting from each source angle's illumination(s) (as in 1.3 above) can be processed to result in a plurality of height maps, one for each viewing angle. If multiple source angles are used, as in step 1.4 above, even more height maps will result. Once all height maps are available from all viewing and source incident angles, they can be combined.

The ability of the systems hereinabove described to generate a plurality of source incident angles mitigates the likelihood of Source Shadowing. If Source Shadowing is nevertheless present, this plurality of source incident angles mitigates its extent.

The ability of the systems hereinabove described to use a plurality of viewing angles mitigates the likelihood of Viewer Shadowing. If Viewer Shadowing is nevertheless present, this plurality of viewing angles mitigates its extent.

The ability of the system to illuminate a target surface from different source angles and to view that target surface from multiple observation angles improves the accuracy and repeatability of measurements of portions of the surface where the surface is visible from more than one viewing angle and/or from more than one source angle. This improvement in measurement fidelity is available, in its most basic form, by averaging the several available results. Additionally, as is the case with phase profilometry, a quality score of the measurement is often available along with the measurement itself, and this can be used to weight each of the several results accordingly.

Operation as described above is reliable, because it is done without macroscopically moving parts.

Operation as described above is fast because no macroscopically moving parts are needed to vary the source incident angle and because data from multiple viewing angles is acquired simultaneously.

The system as described above is comparatively inexpensive, compact and of low weight because it does not require multiple light projectors, multiple cameras, multiple lenses, duplicate electronics or macroscopically moving parts.

In another embodiment the system of FIGS. 9-11 (FIGS. 20-22 in parenthesis) operates as follows:

The computer causes the projector to select more than one illumination mirror 34 (60) at one time. Light from the two or more simultaneously selected paths reaches the target surface 20 (100) and is seen by the viewer as described above. Data from the simultaneously enabled source projection angles may need to be separated before subsequent processing. If required, this separation can be achieved, for example, by:

Color encoding the source light, e.g.: by using a color capable projector 38 and by illuminating one illumination path with blue light and a second illumination path with red light and

Using a color camera 40 where, continuing with the above example, data from the camera's blue and red pixels are separated knowing which color light came from which source illumination path.

Using multiple projection wave numbers where the wave numbers are chosen so that the height reconstruction resulting from one source projection angle does not effect the height reconstruction of another.

Delivering light to more than one illumination mirror at one time offers a speed improvement over using one illumination mirror at a time.

In yet another embodiment, the computer causes the projector to deliver unstructured light to all possible source incident angles.

When all illumination sources are concurrently selected and when no pattern is imposed, the aggregate light becomes less directional and can, if there are enough angled sources, approximate a diffuse light source. Diffuse lighting is advantages for some inspection tasks, for example, fiducial finding.

Commonly available stereo vision range finding techniques can be employed to process data acquired from multiple angles can thus yield 3D data of the target surface.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein.

What is claimed is:

1. An illumination and imaging system, comprising:
a light source;
an image capture device;
a first mirror situated at a predetermined position relative to the light source; and
a second mirror situated at a predetermined position relative to the image capture device.

2. The illumination and imaging system of claim 1, wherein the light source includes a spatial light modulator (SLM).

3. The illumination and imaging system of claim 1, wherein the image capture device includes a camera.

4. The illumination and imaging system of claim 1, further comprising a computer system interfaced to the light source and the image capture device.

5. The illumination and imaging system of claim 4, further comprising a plurality of the first mirrors, wherein the light source is controlled to illuminate a predetermined one of the first mirrors.

6. The illumination and imaging system of claim 5, wherein the light source is controlled to simultaneously illuminate a predetermined set of the first mirrors.

7. The illumination and imaging system of claim 5, wherein the light source is controlled to illuminate the second mirror.

8. The illumination and imaging system of claim 4, further comprising a plurality of the second mirrors, wherein the image capture device is controlled to receive an image from each of the second mirrors.

9. The illumination and imaging system of claim 8, wherein the image capture device is controlled to receive an image from the first mirrors.

10. The illumination and imaging system of claim 5, wherein the first mirrors are arranged on an oblate spheroid such that a convergence point of chief rays within the light source and a convergence point of rays on an illuminated target are coincident with foci of the oblate spheroid.

11. The illumination and imaging system of claim 8, wherein the second mirrors are arranged on an oblate spheroid such that a convergence point of chief rays within the image capture device and a convergence point of rays on an illuminated target are coincident with foci of the oblate spheroid.

12. The illumination and imaging system of claim 5, further comprising a plurality of third mirrors, wherein the light source is controlled to illuminate the predetermined one of the first mirrors via a predetermined one of the third mirrors.

13. The illumination and imaging system of claim 8, further comprising a plurality of third mirrors, wherein the image capture device is controlled to receive the image from the second mirrors via the third mirrors.

14. The illumination and imaging system of claim 1, wherein the light source is configured to illuminate the target using structured light.

15. A manufacturing method including an illumination and imaging method, comprising:
illuminating a target via a first mirror situated at a predetermined position; and
capturing an image of the illuminated target via a second mirror situated at a predetermined position.

16. The method of claim 15, further comprising simultaneously illuminating the target via a plurality of the first mirrors.

17. The method of claim 15, further comprising capturing the image of the illuminated target via a plurality of the first mirrors.

18. The method of claim 15, further comprising illuminating the target via the first mirror via a third mirror.

19. The method of claim 15, further comprising capturing the image of the illuminated target via the second mirror via a third mirror.

20. The method of claim 15, wherein illuminating the target includes illuminating the target using structured light.

21. The method of claim 15, wherein the target is a surface of a part, and wherein the method further comprises assembling the part into a final assembly.

22. The method of claim 21, wherein the part is an electronic component, and wherein the method further comprises mounting the electronic component on a circuit board.
